(19) United States
(12) Patent Application Publication
(10) Pub. No.: US 2024/0283128 A1
(43) Pub. Date: Aug. 22, 2024

(54) ANTENNA MODULE AND ELECTRONIC DEVICE

(71) Applicants: Liang-Che Chou, Taipei City (TW); Wei-Sen Teng, Taipei City (TW); Yu-Chun Hsieh, Taipei City (TW); Guan-Ruei Wu, Taipei City (TW); Jui-Hung Lai, Taipei City (TW)

(72) Inventors: Liang-Che Chou, Taipei City (TW); Wei-Sen Teng, Taipei City (TW); Yu-Chun Hsieh, Taipei City (TW); Guan-Ruei Wu, Taipei City (TW); Jui-Hung Lai, Taipei City (TW)

(73) Assignee: COMPAL ELECTRONICS, INC., Taipei City (TW)

(21) Appl. No.: 18/429,465

(22) Filed: Feb. 1, 2024

Related U.S. Application Data
(60) Provisional application No. 63/446,790, filed on Feb. 17, 2023.

(51) Int. Cl. H01Q 1/22; H01Q 9/04

(52) U.S. Cl. CPC H01Q 1/2266; H01Q 9/0421; H01Q 9/0442

(57) ABSTRACT

An antenna module includes a substrate and an antenna structure. The antenna structure is disposed on the substrate and includes a radiating portion, a feeding portion, a ground plane, and an impedance adjustment portion. The feeding portion is coupled to the radiating portion and the ground plane. The impedance adjustment portion has a connection end portion and a ground end portion opposite to each other. The connection end portion is connected to the radiating portion. The impedance adjustment portion is bent relative to the radiating portion to extend from the connection end portion toward the feeding portion along an extending direction. The ground end portion is connected to the ground plane and near the feeding portion. In addition, an electronic device including the antenna module is also provided.

### CROSS-REFERENCE TO RELATED APPLICATION

This application claims the priority benefit of U.S. provisional application Ser. No. 63/446,790, filed on Feb. 17, 2023. The entirety of the above-mentioned patent application is hereby incorporated by reference herein and made a part of this specification.

### BACKGROUND

### Technical Field

The disclosure relates to an antenna module and an electronic device, and more particularly, to an antenna module including an impedance adjustment portion and an electronic device having the antenna module.

### Description of Related Art

With the development and popularization of wireless communication technology, most consumer electronic devices also function as mobile communication devices. For example, notebook computers are generally provided with an antenna module to transmit and receive wireless signals. However, due to a trend of designing the notebook computers to be thin, light and, compact, a configuration space of the antenna module is limited. Therefore, how to dispose an antenna module with good signal transmission and reception performance in the limited space is an important issue in the art.

### SUMMARY

The disclosure provides an antenna module having good signal transmission and reception performance.

The disclosure provides an electronic device, and an antenna module thereof has good signal transmission and reception performance.

The antenna module in the disclosure includes a substrate and an antenna structure. The antenna structure is disposed on the substrate and includes a radiating portion, a feeding portion, a ground plane, and an impedance adjustment portion. The feeding portion is coupled to the radiating portion and the ground plane. The impedance adjustment portion has a connection end portion and a ground end portion opposite to each other. The connection end portion is connected to the radiating portion. The impedance adjustment portion is bent relative to the radiating portion to extend from the connection end portion toward the feeding portion along an extending direction. The ground end portion is connected to the ground plane and near the feeding portion.

The electronic device in the disclosure includes a device body and an antenna module. The antenna module includes a substrate and an antenna structure. The substrate is disposed on the device body. The antenna structure is disposed on the substrate and includes a radiating portion, a feeding portion, a ground plane, and an impedance adjustment portion. The feeding portion is coupled to the radiating portion and the ground plane. The impedance adjustment portion has a connection end portion and a ground end portion opposite to each other. The connection end portion is connected to the radiating portion. The impedance adjustment portion is bent relative to the radiating portion to extend from the connection end portion toward the feeding portion along an extending direction. The ground end portion is connected to the ground plane and near the feeding portion.

In an embodiment of the disclosure, the impedance adjustment portion is located between the radiating portion and the ground plane in a direction perpendicular to the extending direction.

In an embodiment of the disclosure, there is a gap between the radiating portion and the impedance adjustment portion, and there is another gap between the impedance adjustment portion and the ground plane.

In an embodiment of the disclosure, the ground end portion has two edges perpendicular to each other, and the two edges are respectively connected to the ground plane and the feeding portion.

In an embodiment of the disclosure, the impedance adjustment portion overlaps a low frequency section of the radiating portion in a direction perpendicular to the extending direction.

In an embodiment of the disclosure, the feeding portion is a radio frequency connector.

In an embodiment of the disclosure, the radio frequency connector does not overlap a high frequency section of the radiating portion in a direction perpendicular to the extending direction.

In an embodiment of the disclosure, in the extending direction, the radio frequency connector is located between the impedance adjustment portion and a high frequency section of the radiating portion.

In an embodiment of the disclosure, the electronic device further includes a coaxial cable and a radio frequency module. The radio frequency module is disposed on the device body, and the coaxial cable is connected between the radio frequency connector and the radio frequency module.

In an embodiment of the disclosure, the ground end portion is adjacent to the feeding portion.

In an embodiment of the disclosure, the substrate is a portion of a housing of the device body.

Based on the above, in the antenna module of the disclosure, the antenna structure includes the impedance adjustment portion connected between the radiating portion and the ground plane. Accordingly, the impedance matching of the antenna structure may be optimized by adjusting the gap between the impedance adjustment portion and the radiating portion, the gap between the impedance adjustment portion and the ground plane, and the extending length of the impedance adjustment portion. In addition, in addition to being connected to the ground plane, the ground end portion of the impedance adjustment portion may also be connected to the feeding portion. Accordingly, the impedance adjustment portion and the feeding portion are grounded together and have no potential difference with each other, which enables the signal transmission and reception of the antenna structure to be more stable. Therefore, the antenna module in the disclosure has good signal transmission and reception performance.

### BRIEF DESCRIPTION OF THE DRAWINGS

FIG. 1 is a schematic view of an electronic device according to an embodiment of the disclosure.

FIG. 2 is a schematic view of an antenna module in FIG. 1.

FIG. 3 is a schematic view of some components of an electronic device according to another embodiment of the disclosure.

FIG. 4 is a partial enlarged view of the electronic device in FIG. 3.

### DETAILED DESCRIPTION OF DISCLOSED EMBODIMENTS

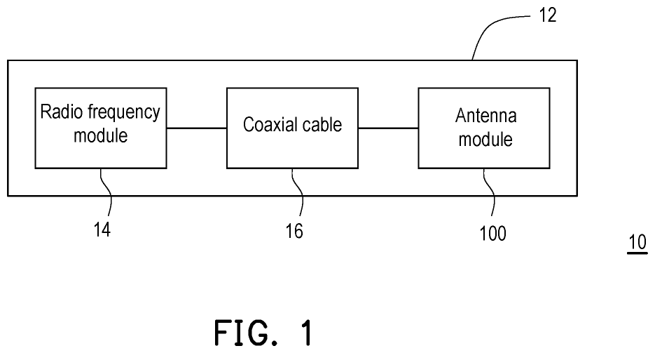

FIG. 1 is a schematic view of an electronic device according to an embodiment of the disclosure. Referring to FIG. 1, an electronic device 10 in this embodiment includes a device body 12, a radio frequency module 14, and an antenna module 100. The radio frequency module 14 and the antenna module 100 are disposed on the device body 12. The radio frequency module 14 transmits and receives wireless signals through the antenna module 100. The electronic device 10 may be a notebook computer or other types of electronic products, and the disclosure is not limited thereto.

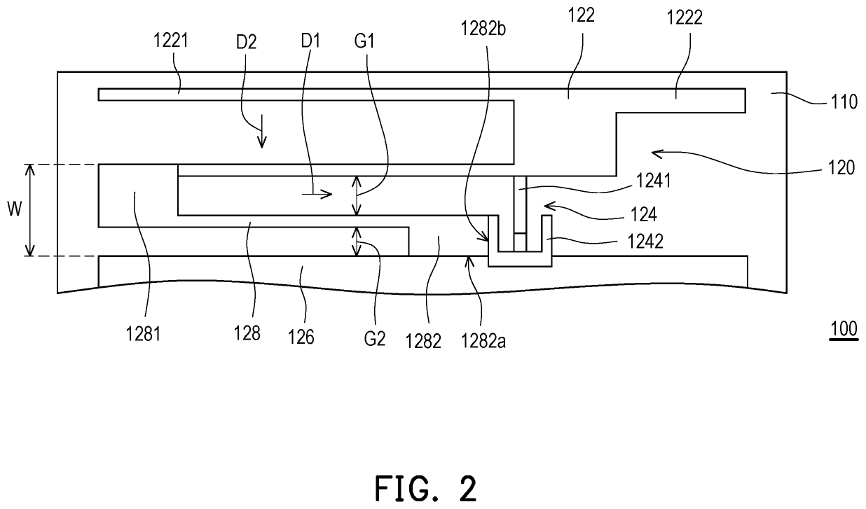

FIG. 2 is a schematic view of an antenna module in FIG. 1. Referring to FIG. 2, the antenna module 100 in this embodiment includes a substrate 110 and an antenna structure 120. The substrate 110 is, for example, a dielectric substrate formed by an insulation material, which is disposed on the device body 12 shown in FIG. 1. The antenna structure 120 is disposed on the substrate 110 and includes a radiating portion 122, a feeding portion 124, a ground plane 126, and an impedance adjustment portion 128. The feeding portion 124 is coupled to the radiating portion 122 and the ground plane 126. The radiating portion 122 and the impedance adjustment portion 128 are integrally formed by a conductive metal material, for example.

The impedance adjustment portion 128 has a connection end portion 1281 and a ground end portion 1282 opposite to each other. The connection end portion 1281 is connected to the radiating portion 122. The impedance adjustment portion 128 is bent relative to the radiating portion 122 to extend from the connection end portion 1281 toward the feeding portion 124 along an extending direction D1. In a direction D2 perpendicular to the extending direction D1, the impedance adjustment portion 128 is located between the radiating portion 122 and the ground plane 126. There is a gap G1 between the radiating portion 122 and the impedance adjustment portion 128, and there is another gap G2 between the impedance adjustment portion 128 and the ground plane 126. The ground end portion 1282 is connected to the ground plane 126 and near the feeding portion 124.

In this embodiment, the ground end portion 1282 is formed adjacent to the feeding portion 124 as shown in FIG. 2. However, the disclosure is not limited thereto. In other embodiments, the ground end portion 1282 may be near the feeding portion 124 but maintain an appropriate distance from the feeding portion 124. That is, the ground end portion 1282 and the feeding portion 124 are not adjacent to each other.

As mentioned above, in the antenna module 100 in this embodiment, the antenna structure 120 includes the impedance adjustment portion 128 connected between the radiating portion 122 and the ground plane 126. Accordingly, by adjusting the gap G1 between the impedance adjustment portion 128 and the radiating portion 122, the gap G2 between the impedance adjustment portion 128 and the ground plane 126, and an extending length of the impedance adjustment portion 128 on the extending direction D1, a corresponding capacitance value and inductance value are changed to optimize impedance matching of the antenna structure 120. In addition, in addition to being connected to the ground plane 126, the ground end portion 1282 of the impedance adjustment portion 128 may be further connected to the feeding portion 124. Accordingly, the impedance adjustment portion 128 and the feeding portion 124 are grounded together and have no potential difference with each other, which may enable signal transmission and reception of the antenna structure 120 to be more stable. Therefore, a low frequency bandwidth of the antenna module 100 in this embodiment may be increased from 100 MHz to 300 MHz, for example, so that the antenna module 100 in this embodiment has good signal transmission and reception performance.

In this embodiment, the ground end portion 1282 of the impedance adjustment portion 128 is a rectangle and has two edges 1282a and 1282b perpendicular to each other, for example, and is connected to the ground plane 126 and the feeding portion 124 through the two edges 1282a and 1282b respectively. In other embodiments, the ground end portion 1282 may have other suitable shapes, and the disclosure is not limited thereto. In addition, a size W of the impedance adjustment portion 128 in this embodiment in the direction D2 perpendicular to the extending direction D1 is, for example, less than 6 mm to avoid excessively increasing a size of the antenna module 100 due to a configuration of the impedance adjustment portion 128.

The feeding portion 124 in this embodiment is, for example, a radio frequency connector. Correspondingly, the electronic device 10 further includes a coaxial cable 16 (shown in FIG. 1). The coaxial cable 16 is connected between the radio frequency connector (the feeding portion 124) and the radio frequency module 14 to transmit signals between the radio frequency connector (the feeding portion 124) and the radio frequency module 14. Through this configuration, when manufacturing the antenna module 100, there is no need to connect the coaxial cable 16 to the antenna structure 120 by soldering, thereby simplifying the difficulty of manufacturing and assembly. Furthermore, since the coaxial cable 16 and the radio frequency connector (the feeding portion 124) are not fixed to each other by soldering as mentioned above, the coaxial cable 16 and the antenna module 100 may be easily separated from each other to facilitate maintenance and to facilitate separate replacement of the antenna module 100 or the coaxial cable 16. Furthermore, when one of the coaxial cable 16 and antenna module 100 is damaged, the entire set of the coaxial cable 16 and the antenna module 100 is not required to be discarded together.

In this embodiment, for example, a core 1241 of the radio frequency connector (the feeding portion 124) is connected to the radiating portion 122 by soldering, and a ground structure 1242 of the radio frequency connector (the feeding portion 124) is connected to the radiating portion 122 by soldering. However, the disclosure is not limited thereto. A connection method between the radio frequency connector (the feeding portion 124) and the coaxial cable 16 is known in the art. Therefore, the same details will not be repeated in the following.

In this embodiment, the impedance adjustment portion 128 overlaps a low frequency section 1221 of the radiating portion 122 in the direction D2 perpendicular to the extending direction D1, and the radio frequency connector (the feeding portion 124) is located between the impedance adjusting portion 128 and a high frequency section 1222 of the radiating portion 122 in the extending direction D1 of the impedance adjusting portion 128. Therefore, the radio frequency connector (the feeding portion 124) does not overlap the high frequency section 1222 of the radiating portion 122 in the direction D2 perpendicular to the extending direction D1 of the impedance adjustment portion 128, and the radio frequency connector (the feeding portion 124) is compactly adjacent to the impedance adjustment portion 128. Accordingly, the radio frequency connector (the feeding portion 124) may be prevented from being too close to the high frequency section 1222 of the radiating portion 122 to cause impedance mismatch, and a design of the compact and small size of the antenna module 100 may be maintained.

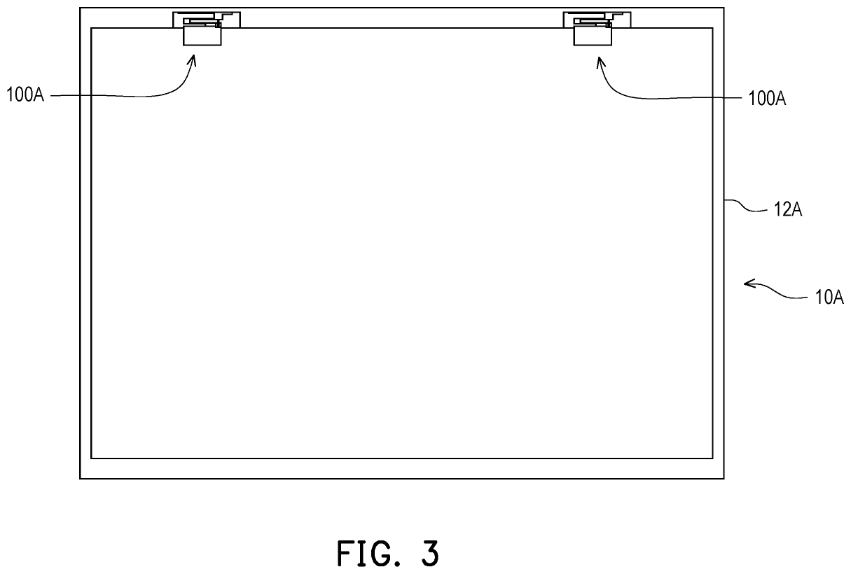

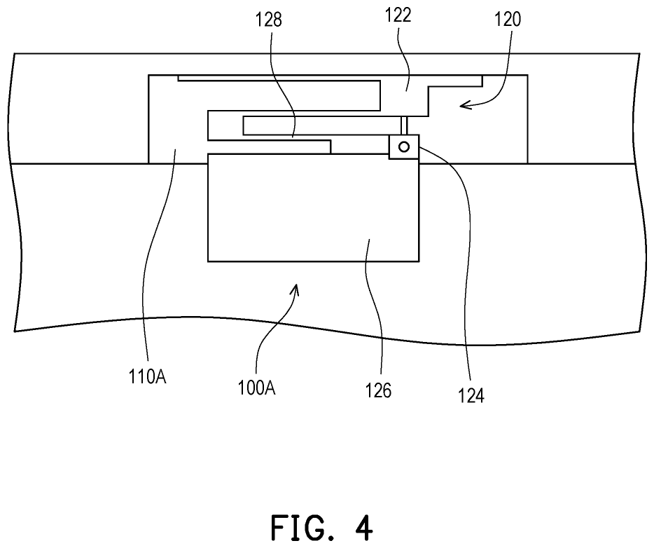

FIG. 3 is a schematic view of some components of an electronic device according to another embodiment of the disclosure. FIG. 4 is a partial enlarged view of the electronic device in FIG. 3. A device body 12A of an electronic device 10A in FIG. 3 is, for example, a screen of a notebook computer. A configuration and function of an antenna module 100A are substantially the same as those of the antenna module 100 in the previous embodiment. Therefore, the same details will not be repeated in the following. A difference between the antenna module 100A and the antenna module 100 is that a substrate 110A of the antenna module 100A is a portion of a housing (e.g., a back cover of the screen) of the device body 12A. Specifically, the radiating portion 122, the ground plane 126, and the impedance adjustment portion 128 of the antenna module 100A may be preformed on the housing of the device body 12A through processes such as laser engraving and sputtering, and then the radio frequency connector (the feeding portion 124) is installed on the housing of the device body 12A to be connected to the radiating portion 122, the ground plane 126, and the impedance adjustment portion 128.

Based on the above, in the antenna module of the disclosure, the antenna structure includes the impedance adjustment portion connected between the radiating portion and the ground plane. Accordingly, the impedance matching of the antenna structure may be optimized by adjusting the gap between the impedance adjustment portion and the radiating portion, the gap between the impedance adjustment portion and the ground plane, and the extending length of the impedance adjustment portion. In addition, in addition to being connected to the ground plane, the ground end portion of the impedance adjustment portion may also be connected to the feeding portion. Accordingly, the impedance adjustment portion and the feeding portion are grounded together and have no potential difference with each other, which enables the signal transmission and reception of the antenna structure to be more stable. Therefore, the antenna module in the disclosure has good signal transmission and reception performance.

What is claimed is:

1. An antenna module, comprising:
a substrate; and
an antenna structure disposed on the substrate and comprising a radiating portion, a feeding portion, a ground plane, and an impedance adjustment portion,
wherein the feeding portion is coupled to the radiating portion and the ground plane, the impedance adjustment portion has a connection end portion and a ground end portion opposite to each other, the connection end portion is connected to the radiating portion, the impedance adjustment portion is bent relative to the radiating portion to extend from the connection end portion toward the feeding portion along an extending direction, and the ground end portion is connected to the ground plane and near to the feeding portion.

2. The antenna module according to claim 1, wherein the impedance adjustment portion is located between the radiating portion and the ground plane in a direction perpendicular to the extending direction.

3. The antenna module according to claim 1, wherein there is a gap between the radiating portion and the impedance adjustment portion, and there is another gap between the impedance adjustment portion and the ground plane.

4. The antenna module according to claim 1, wherein the ground end portion has two edges perpendicular to each other, and the two edges are respectively connected to the ground plane and the feeding portion.

5. The antenna module according to claim 1, wherein the impedance adjustment portion overlaps a low frequency section of the radiating portion in a direction perpendicular to the extending direction.

6. The antenna module according to claim 1, wherein the feeding portion is a radio frequency connector.

7. The antenna module according to claim 6, wherein the radio frequency connector does not overlap a high frequency section of the radiating portion in a direction perpendicular to the extending direction.

8. The antenna module according to claim 6, wherein in the extending direction, the radio frequency connector is located between the impedance adjustment portion and a high frequency section of the radiating portion.

9. The antenna module according to claim 1, wherein the ground end portion is adjacent to the feeding portion.

10. An electronic device, comprising:
a device body; and
an antenna module, comprising:
a substrate disposed on the device body; and
an antenna structure disposed on the substrate and comprising a radiating portion, a feeding portion, a ground plane, and an impedance adjustment portion,
wherein the feeding portion is coupled to the radiating portion and the ground plane, the impedance adjustment portion has a connection end portion and a ground end portion opposite to each other, the connection end portion is connected to the radiating portion, the impedance adjustment portion is bent relative to the radiating portion to extend from the connection end portion toward the feeding portion along an extending direction, and the ground end portion is connected to the ground plane and near the feeding portion.

11. The electronic device according to claim 10, wherein the impedance adjustment portion is located between the radiating portion and the ground plane in a direction perpendicular to the extending direction.

12. The electronic device according to claim 10, wherein there is a gap between the radiating portion and the impedance adjustment portion, and there is another gap between the impedance adjustment portion and the ground plane.

13. The electronic device according to claim 10, wherein the ground end portion has two edges perpendicular to each other, and the two edges are respectively connected to the ground plane and the feeding portion.

14. The electronic device according to claim 10, wherein the impedance adjustment portion overlaps a low frequency section of the radiating portion in a direction perpendicular to the extending direction.

15. The electronic device according to claim 10, wherein the feeding portion is a radio frequency connector.

16. The electronic device according to claim 15, wherein the radio frequency connector does not overlap a high frequency section of the radiating portion in a direction perpendicular to the extending direction.

17. The electronic device according to claim 15, wherein in the extending direction, the radio frequency connector is located between the impedance adjustment portion and a high frequency section of the radiating portion.

18. The electronic device according to claim 15, further comprising a coaxial cable and a radio frequency module, wherein the radio frequency module is disposed on the device body, and the coaxial cable is connected between the radio frequency connector and the radio frequency module.

19. The electronic device according to claim 10, wherein the ground end portion is adjacent to the feeding portion.

20. The electronic device according to claim 10, wherein the substrate is a portion of a housing of the device body.
